(19) United States
(12) Patent Application Publication
(10) Pub. No.: US 2015/0063495 A1
(43) Pub. Date: Mar. 5, 2015

(54) SOFT DETECTION OF M-ARY DPSK SIGNALS

(71) Applicant: BlackBerry Limited, Waterloo (CA)

(72) Inventors: Shouxing Qu, Kanata (CA); Huan Wu, Kanata (CA); Yan Xin, Kanata (CA); Arnold Sheynman, Rolling Meadows, IL (US)

(21) Appl. No.: 14/011,492

(22) Filed: Aug. 27, 2013

(51) Int. Cl. H04L 27/22

(52) U.S. Cl. CPC H04L 27/22
USPC 375/330

(57) ABSTRACT

In some implementations, a method of a receiver includes receiving an M-ary differential phase-shift keying (DPSK) signal containing a phase offset and optionally a phase rotation. The phase offset of the received signal may be estimated. A soft detection metric employing the estimated phase offset may be calculated to provide enhanced receiver performance. The method may include subtracting the phase offset estimate from the received signal prior to calculating the soft detection metric and/or de-rotating the phase of the received signal by the same amount of the phase rotation prior to estimating the phase offset of the received signal. Estimating the phase offset may be based on maximum likelihood principle. The soft detection metric may be a log-likelihood ratio (LLR) for soft detection of the received M-ary DPSK signal and the calculation of the LLR may be based upon a conditional joint probability density function of two consecutively received symbols.

### FIELD

This disclosure relates to soft detection of M-ary DPSK signals.

### BACKGROUND

In wireless and wireline communications, information transmission is often accomplished by sending from the transmitter to the receiver a high-frequency carrier signal that is modulated by the message bits and transmitted over, for example, radio frequency channels, copper wires, optical fibers, cables, or any other appropriate media. Various modulation schemes may be used for signal transmission. Example modulation schemes include amplitude-shift keying (ASK), phase-shift keying (PSK), frequency-shift keying (FSK), quadrature amplitude modulation (QAM), and variations of these or other modulation schemes.

Additionally, differential phase-shift keying (DPSK) modulation may not require the use of pilot signals in the data stream and thus saves overhead. DPSK modulation has been employed in a wide range of scenarios, including Bluetooth and IEEE communications standards. However, conventional DPSK methods may have various drawbacks, including limited bit-error-rate performance, limited data throughput, and limited battery life.

### DESCRIPTION OF DRAWINGS

FIG. 1 is an example mobile communication system.

FIG. 2 is a schematic illustrating an example network node.

FIG. 3 is a schematic illustrating an example user-equipment device.

FIGS. 4A and 4B are example transmitter and receiver, respectively, for wireless communications using M-ary differential PSK (DPSK) modulation and channel coding.

FIG. 5 is a module of generation of M-ary DPSK signal.

FIG. 6 is a schematic illustrating an example of hard detection of M-ary DPSK signal.

FIG. 7 is a schematic illustrating an example baseband model of a communication system using DPSK modulation with low-density parity check (LDPC) coding.

FIGS. 8-11 are schematics illustrating example receiver structures for soft detection of M-ary DPSK signals.

FIG. 12 is a plot illustrating example bit error rate (BER) performances of Binary-DPSK with (672,336)-LDPC under an additive white Gaussian noise (AWGN) Channel.

FIG. 13 is a plot illustrating example BER performances of Quaternary-DPSK and 8-DPSK with (672,336)-LDPC under AWGN Channel.

FIG. 14 is a flowchart illustrating an example process for soft-detection of M-ary DPSK signals.

### DETAILED DESCRIPTION

The present embodiments include a method and system that estimate the unknown phase offset embedded in a received signal. The obtained estimate may then be either used to remove the phase offset or exploited in calculation of the log-likelihood ratio (LLR), the soft value for each bit, based on a newly derived unified expression. The new solution may be implemented in software, hardware, or embedded in a chipset. The present embodiments may improve BER performance, increase data throughput, and increase battery life as compared to conventional techniques.

In one aspect, the phase offset (PO) of a current signal, or portion thereof, may be estimated with respect to the previous signal, or portion thereof, received by the receiver. Then that estimated phase offset may be used in a log-likelihood ratio (LLR) calculation. As an example, an estimate of the unknown phase offset may be derived from an approximate maximum-likelihood estimation (MLE). N received symbols may be used in the MLE, which assumes that the phase offset is invariant during the period of the N symbols. Then, the LLR may be calculated using the estimated phase offset.

More generally, the present disclosure is directed to soft detection of DPSK signals. In many applications of wireless communications, transmitted signals propagate through fading channels and experience random variations on both signal magnitude and signal phase, which may make recovering the information carried by the signals difficult. Phase-shift keying (PSK) modulation scheme, a constant envelop modulation technique, may be robust to random variations in the magnitude, since none of the information is carried by the signal magnitude. However, PSK may be sensitive to the random phase offset (PO), since all the information is carried by absolute phase of the signal. To recover the information in a PSK receiver, the receiver may need a phase reference (and/or phase synchronization) and may use extra structural and computational complexity. In some instances, even in a static channel, acquiring a strict phase reference without phase ambiguity in a receiver may require additional training symbols to be transmitted.

In some instances, a PSK signal may be vulnerable to imperfect frequency synchronization between the transmitter and the receiver. For example, even a small residual frequency offset could lead to accumulated phase changes (called phase drifting) along the symbols in a packet and cause phase distortion of the received signal. In turn, the symbol recovery may be impaired and system performance may degrade. To compensate the phase drifting, training symbols are often (for example, periodically) inserted among the transmitted data symbols at the transmitter and the receiver may execute phase tracking algorithms. This approach may reduce efficiency and increase complexity.

To alleviate use of strict phase synchronization, differential PSK (DPSK) modulation may be used. In DPSK, the information is not carried by the absolute phase, but by the relative phase, i.e., the phase difference between a currently received symbol and a previously received symbol. Thus, in DPSK, the receiver may use the phase of the previously received signal as the reference and does not need to know the signal's absolute phase, as long as the phase offset has no significant variation during two contiguous symbol intervals. This approach may simplify the receiver complexity and make DPSK robust to the unknown random and/or slowly varying phase offset.

In general, DPSK may be of M-ary DPSK with M≧2, where M=2^{m}, m being a positive integer, with each symbol carrying m bits of information. When m=1, the M-ary DPSK becomes binary DPSK (BDPSK). DPSK may be employed in various wireless and wireline communications and networks that include, for example, Bluetooth communications, wireless local area network (WLAN) communications, millimeter wave (mmWave) communications, optical fiber communications, and others. As one example, version 2.0+ Bluetooth Enhanced Data Rate (EDR) standard and version 3.0 EDR use π/4-QDPSK and octal DPSK (M=8). By adopting these DPSK schemes, the peak data rate of Bluetooth may increase to 2 Mb/sec. and 3 Mb/sec. from 1 Mb/sec. of its previous version, respectively. As another example, IEEE 802.11ad standard for Gb/sec. short-range data communications in the unlicensed 60 GHz RF band uses the binary DPSK for the control channel. DPSK may be applied to other types of communications and be adopted in other protocol or standards.

In modern communications systems, modulation schemes are typically used together with error-correcting channel coding techniques to enhance the reliability of signal transmission. Various channel codes may be used, for example, convolutional code, turbo code or low-density parity check (LDPC) code. In general, the demodulator in the receiver may perform hard detection (HD) or soft detection (SD) on the modulating bits, depending on the used channel coding technique and design preferences. For instance, HD may be performed in applications where none or simple channel coding is applied, or the receiver simplicity takes precedence over achieving the best system performance. On the other hand, when the advanced iterative coding techniques such as turbo code or LDPC code are employed, the receiver may perform SD (e.g., exclusively) to supply a soft detection output (e.g., log-likelihood ratio (LLR)) for every bit to the channel decoder.

As mentioned above, random phase offset may be embedded in the received signal. The phase offset is generally unknown upon the receipt of the signal. Since DPSK signal does not rely upon the absolute phase of the received signal and may be robust to the phase offset, existing DPSK receivers do not estimate, identify, or otherwise exploit the phase offset of the received signal. The phase offset remains unknown during symbol detection and channel decoding at the receiver. In some implementations of the present disclosure, the phase offset embedded in the received DPSK signals may be used when calculating SD outputs (e.g., LLR) in M-ary DPSK receivers. For example, the phase offset may be estimated and the estimated phase offset may be used in LLR calculation.

Using the phase offset in soft detection of DPSK signals as described in this disclosure may provide one or more advantages. For example, decoding errors and the number of retransmissions may be reduced, and better error performance may be achieved. Furthermore, less transmission power may be used or the system throughput may increase (e.g., by increasing the order of modulation), without compromising the error performance. Other advantages and benefits may also be achieved.

### I. Exemplary Communication Systems

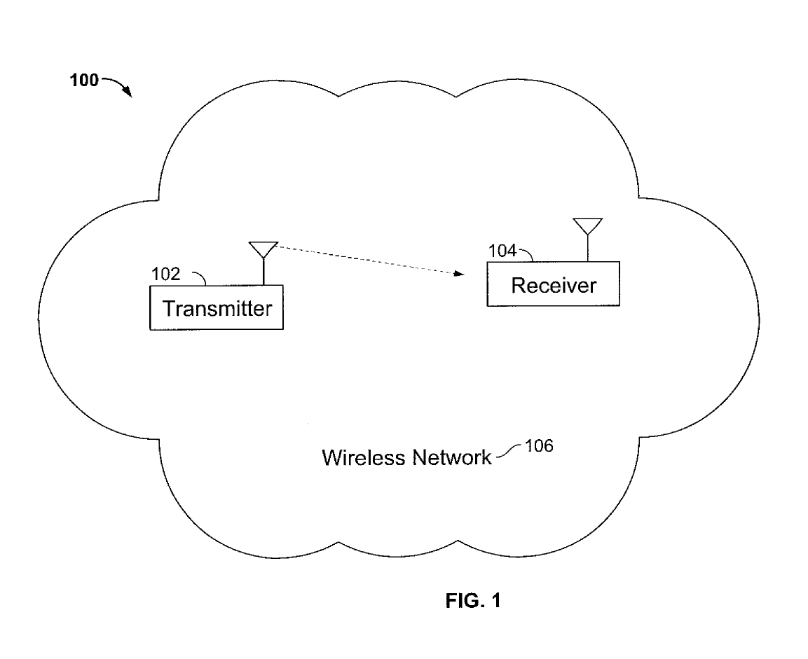

FIG. 1 is an example mobile communication system 100. In the illustrated implementations, the mobile communication system 100 includes a transmitter 102 communicably coupled to a receiver 104 through a wireless network 106. In some implementations, the transmitter 102 may be allocated a radio resource in the wireless network 106 and transmit a radio frequency (RF) signal to the receiver 104 using the allocated resource (e.g., time, frequency bandwidth, etc.). The transmitted signal may include one or more of data packets, control signals, or other information. A data packet may be one or more transmissions. The transmitted signal may be encoded using a channel coding (e.g., turbo code, LDPC code) and modulated using a modulation scheme (e.g., PSK, DPSK, ASK, FSK, QAM). The transmitter 102 may then transmit the modulated signal via one or more antennas to the air. The receiver 102 may receive the RF signal from the air, demodulate and decode the received signal according to the modulation and channel coding schemes used at the transmitted 102 to recover the transmitted information. The transmitter 102 may communicate to the receiver 104 using any appropriate protocol stack at any appropriate time, for example, sequentially, periodically, simultaneously, or in another manner.

The transmitter 102 may be any electronic device configured to wirelessly transmit, for example, within the mobile communication system 100. The transmitter 102 may transmit voice data, video data, user data, application data, multimedia data, text, web content, or any other content. In some instances, the data may be properly processed according to a modulation and a channel coding scheme before transmission. As a specific example, the transmitter may apply LDPC coding and the encoded data stream is used to generate M-ary DPSK signal. The M-ary DPSK signal may then be up-converted to a carrier frequency to be transmitted as an RF signal over the air. In some implementations, the transmitter 102 may be allocated a radio resource from the receiver 104 or the wireless network 106. For example, the transmitter 102 may receive a broadcast of radio-resource assignments or availability of radio resources including the radio resource and associated selection criteria for transmitter 102. In some implementations, the assignments may be transmitted using dedicated signals (e.g., control signals). Regardless, the assignments or availability of radio resources may include or otherwise identify at least one of shared radio resources, associated selection criteria, preambles, or locations of preambles within a payload.

The receiver 104 may be any electronic device configured to wirelessly receive, for example, within the mobile communication system 100. For instance, the receiver 104 may receive an RF signal from one or more antennas and down-convert the received RF signal to a baseband signal for signal processing. With the baseband signal, the receiver 104 may perform demodulation and decoding to recover the transmitted information. In some instances, the receiver 104 may perform soft detection to calculate a soft detection output (e.g., log-likelihood ratio (LLR)) and use the soft detection output as the input of channel decoding to recover information transmitted from the transmitter 102. The receiver 104 may receive voice data, video data, user data, application data, multimedia data, text, web content, or any other content. In some implementations, the receiver 104 is configured to receive, from the transmitter 102, user data with varying transmission delays transmitted over the radio resource with varying resource identities. The receiver 104 may receive multiple transmissions in a shared resource and separate the multiple transmissions using, for example, at least one of multi-user detection (MUD), successive interference cancellation (SIC), based on maximum likelihood detection (MLD) criteria or in general any other optimization criteria.

In regard to a general description of the system 100, the transmitter 102 or the receiver 104 may be user equipment (UE), a network node, or any other device in the mobile communication system 100. For user equipment, the transmitter 102 or the receiver 104 may be referred to as mobile electronic device, user device, mobile station, subscriber station, portable electronic device, mobile communications device, wireless modem, or wireless terminal. The term “UE” may also refer to any hardware or software component that may terminate a communication session for a user. In addition, the terms “user equipment,” “UE,” “user equipment device,” “user agent,” “UA,” “user device,” and “mobile device” may be used synonymously herein.

Examples of user equipment may include a cellular phone, personal data assistant (PDA), smart phone, laptop, tablet personal computer (PC), pager, portable computer, portable gaming device, wearable electronic device, or other mobile communications device having components for communicating voice or data via a mobile communication network. Other examples include, but are not limited to, a television, a remote controller, a set-top box, a computer monitor, a computer (including a tablet, a desktop computer, a handheld or laptop computer, a netbook computer), a microwave, a refrigerator, a stereo system, a cassette player or recorder, a DVD player or recorder, a CD player or recorder, a VCR, an MP3 player, a radio, a camcorder, a camera, a digital camera, a portable memory chip, a washer, a dryer, a washer/dryer, a copier, a facsimile machine, a seamier, a multi-functional peripheral device, a wristwatch, a clock, and a game device, etc. The transmitter 102 or the receiver 104 may include a device and a removable memory module, such as a Universal Integrated Circuit Card (UICC) that includes a Subscriber Identity Module (SIM) application, a Universal Subscriber Identity Module (USIM) application, or a Removable User Identity Module (R-UIM) application. Alternatively, the transmitter 102 or the receiver 104 may include the device without such a module.

For the network node, the transmitter 102 or the receiver 104 may be referred to a base station, an access node, an access device, a relay node, a Universal Terrestrial Radio Access Network (UTRAN) node B, an eNB of an evolved Universal Terrestrial Radio Access Network (E-UTRAN), a network element, or a network component. In some implementations, in addition to wireless communications, the transmitter 102 or the receiver 104 are capable of wireline communications. For example, the transmitter 102 or the receiver 104 may be connected to a core network via a backhaul link, including an optical fiber or cable. In some instances, the transmitter 102 or the receiver 104 may be connected with each other via wirelines including copper wires, optical fiber, cables. The transmitter 102 or the receiver 104 may communicate with each other in an “Ad Hoc” mode.

The wireless network 106 may communicate based on orthogonal frequency division multiplexing (OFDM), orthogonal frequency division multiple access (OFDMA), space-division multiplexing (SDM), frequency-division multiplexing (FDM), time-division multiplexing (TDM), code division multiplexing (CDM), or others. The wireless network 106 may transmit information using MAC and PHY layers. Communications within the wireless network 106 may be transmitted in accordance with Long Term Evolution (LTE), Global System for Mobile Communication (GSM) protocols, Code Division Multiple Access (CDMA) protocols, Universal Mobile Telecommunications System (UMTS), Unlicensed Mobile Access (UMA), direct device-to-device (DD2D) protocols, or others.

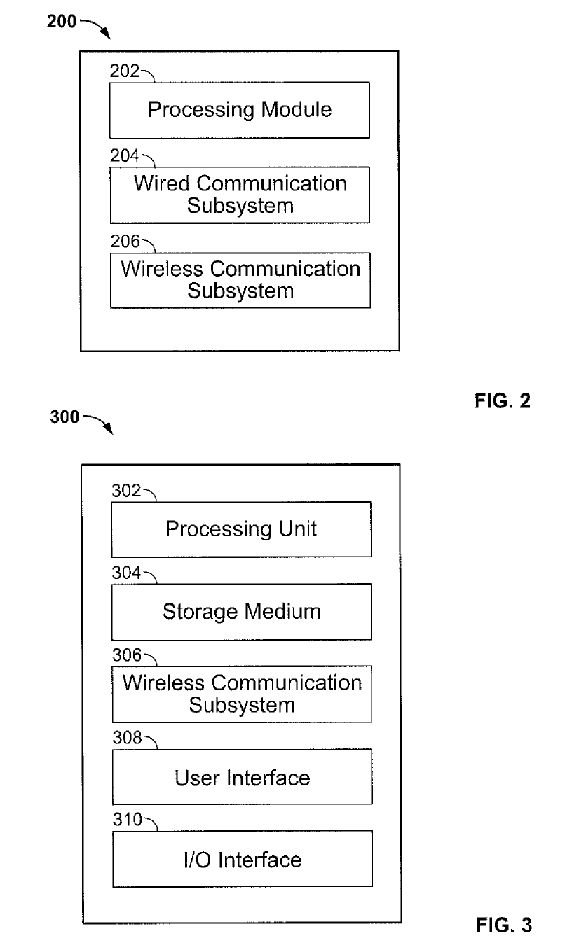

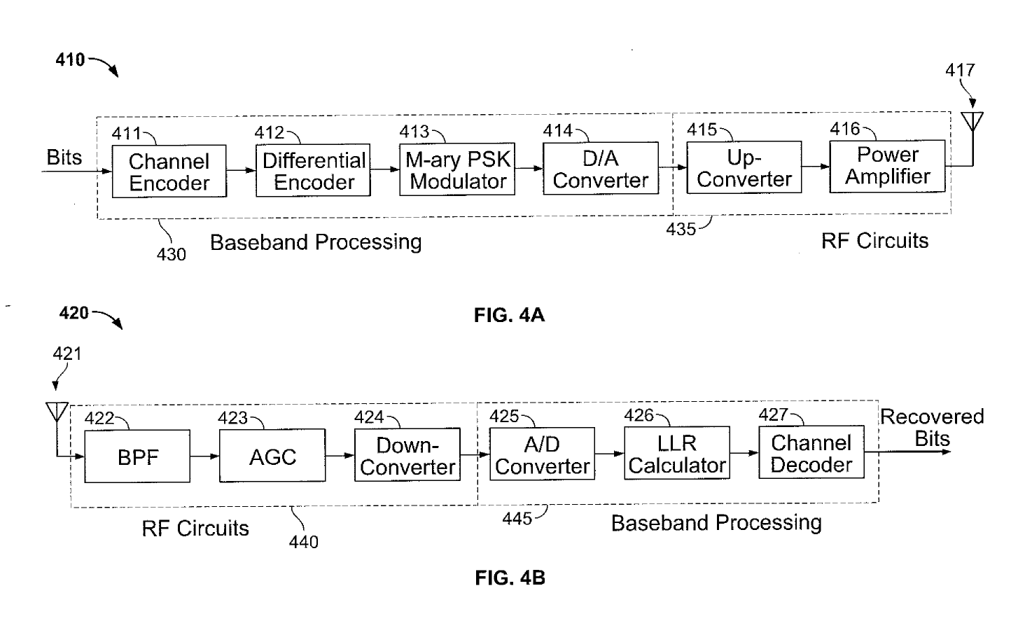

FIG. 2 is a schematic illustrating an example network node 200. As mentioned with regard to FIG. 1, the network node 200 may be an example of the transmitter 102 or the receiver 104. The network node 200 may transmit and receive signals that use various modulation and channel coding schemes. As an example, the network node 200 may transmit and receive an M-ary DPSK signal with LDPC or turbo coding. The example network node 200 includes a processing module 202, a wired communication subsystem 204, and a wireless communication subsystem 206. The processing module 202 may include one or more processing components (alternatively referred to as “processors” or “central processing units” (CPUs)) operable to execute instructions associated with one or more of the processes, steps, or actions described above in connection with one or more of the implementations disclosed herein (for example, the operations described with respect to FIGS. 4-14). The processing module 202 may also include other auxiliary components, such as random access memory (RAM), read only memory (ROM), or secondary storage (for example, a hard disk drive or flash memory). The processing module 202 may execute certain instructions and commands to provide wireless or wired communication, using the wired communication subsystem 204 or a wireless communication subsystem 206. A skilled artisan will readily appreciate that various other components may also be included in the example network node 200.

FIG. 3 is a schematic illustrating an example UE 300. As mentioned with regard to FIG. 1, the UE 300 may be an example of the transmitter 102 or the receiver 104, The UE 300 may transmit and receive signals that use various modulation and channel coding schemes. As an example, the UE 300 may transmit and receive an M-ary DPSK signal with LDPC or turbo coding. The example UE 300 includes a processing unit 302, a computer readable storage medium 304 (for example, ROM or flash memory), a wireless communication subsystem 306, an interface 308, and an I/O interface 310. Similar to the processing module 202 of FIG. 2, the processing unit 302 may include one or more processing components (alternatively referred to as “processors” or “central processing units” (CPUs)) configured to execute instructions related to one or more of the processes, steps, or actions described above in connection with one or more of the implementations disclosed herein (for example, operations described with respect to FIGS. 4-14). The wireless communication subsystem 306 may be configured to provide wireless communications for data information or control information provided by the processing unit 302. The wireless communication subsystem 306 may include, for example, one or more antennas, a receiver, a transmitter, a local oscillator, a mixer, and a digital signal processing (DSP) unit. In some embodiments, the wireless communication subsystem 306 may support advanced multi-user detection (MUD) receivers and multiple input multiple output (MIMO) transmissions.

The interface 308 may include, for example, one or more of a screen or touch screen (for example, a liquid crystal display (LCD), a light emitting display (LED), an organic light emitting display (OLED), a microelectromechanical system (MEMS) display), a keyboard or keypad, a trackball, a speaker, and a microphone. The I/O interface 310 may include, for example, a universal serial bus (USB) interface. A skilled artisan will readily appreciate that various other components may also be included in the example UE device 300.

### II. Exemplary Transmitter and Receiver

FIG. 4A is an example transmitter 410 for wireless communications using M-ary differential PSK (M-DPSK) modulation and channel coding. The example transmitter 410 may be, for example, the transmitter 102 in FIG. 1. In some instances, the example transmitter 410 may be included in the example network node 200 in FIG. 2, the example UE 300 in FIG. 3, or any other appropriate device. As illustrated, the example transmitter 410 includes a baseband processing subsystem 430, a radio frequency (RF) circuit subsystem 435, and one or more antennas 417. The baseband processing subsystem 430 may include any appropriate software, hardware, firmware, or a combination thereof for baseband signal processing including, for example, modulation, channel encoding, or others. As illustrated, the baseband processing subsystem 430 includes a channel encoder 411, a differential encoder 412, an M-ary PSK modulator 413, and a digital-to-analog (D/A) converter 414. The baseband processing subsystem 430 may include additional or different components without departing from the scope of this disclosure. The RF circuit subsystem 435 may include any appropriate software, hardware, firmware, or a combination configured for RF processing including, for example, up-converting baseband signal to radio frequency, power amplification, or others. As illustrated, the RF circuit subsystem 435 includes an up-converter 415, and a power amplifier 416. The RF circuit subsystem 435 may include additional or different components without departing from the scope of this disclosure.

In some implementations, information bits may be input into the channel encoder 411 for channel coding. The channel encoder 411 may be configured to execute, for example, channel coding algorithms of convolutional code, turbo code, LDPC code, or any other appropriate channel code. In some instances, the channel encoder 411 may be referred to as an error-correcting encoder. After the channel encoding, the encoded bits are passed to the differential encoder 412 to perform differential coding. The differentially encoded bit stream is then applied to the M-ary PSK modulator 413 for phase-shift keying (PSK) modulation. The combination of the differential encoder 412 and the Mary PSK modulator 413 acts as an example of an M-ary DPSK modulator. The M-ary DPSK modulated symbols may be converted to analog signals by the digital-to-analog (D/A) converter 414, resulting in an analog baseband signal. The analog baseband signal may then be, via up-converter 415, tuned from baseband to radio frequency (RF) band (for example, a carrier frequency band assigned to the transmitter 410 for transmission). The RF signal may be amplified by the amplifier 416 and transmitted by one or more antennas 417 to the air. The RF signal may experience path loss, amplitude and phase variations, distortions, or a combination thereof during propagation over the RF channel and eventually arrive at a receiver.

FIG. 4B is an example receiver 420 for wireless communications using M-ary differential PSK modulation and channel coding. The example transmitter 420 may be, for example, the receiver 104 in FIG. 1. In some instances, the example receiver 420 may be included in the example network node 200 in FIG. 2, the example UE 300 in FIG. 3, or any other appropriate device. As illustrated, the example receiver 420 includes a RF circuit subsystem 440, a baseband processing subsystem 445, and one or more antennas 421. The RF circuit subsystem 440 may include any appropriate software, hardware, firmware, or a combination configured for RF processing including, for example, down-converting RF signal to baseband, power amplification, or other operations. For instance, the illustrated RF circuit subsystem 440 may include one or more antennas 421, a band-pass filter (BPF) 422, an automatic gain controller (AGC) 423, and a down-converter 424. The RF circuit subsystem 440 may include additional or different components without departing from the scope of this disclosure. The baseband processing subsystem 445 may include any appropriate software, hardware, firmware, or a combination of these and other elements and be configured for baseband processing (e.g., demodulation, channel decoding, signal detection, etc.). For instance, the illustrated baseband processing subsystem 445 includes an analog-to-digital (A/D) converter 425, a log-likelihood ratio calculator 426, and a channel decoder 427. The baseband processing subsystem 445 may include additional or different components without departing from the scope of this disclosure.

In some implementations, the one or more antennas 421 receive RF signals from the air. The received RF signal may pass through the BPF 422 and the AGC 423 to filter out the out-of-hand noise and interference and to amplify the signal to a specified magnitude level, respectively. The down-convertor 424 down converts the processed RF signal to the baseband. The A/D converter 425 converts the received baseband signal to a digital signal, and the digital signal may then be demodulated and decoded. For example, the received digital signal may be passed to the LLR calculator 426 for DPSK demodulation with soft detection. The output of the LLR calculator 426 may be passed to the channel decoder 427 to recover the transmitted information bits. The channel decoder 427 may perform a channel decoding algorithm matched to the channel code (e.g., convolutional code, turbo code, LDPC code) used on the transmitter side.

### III. Exemplary M-DPSK Techniques

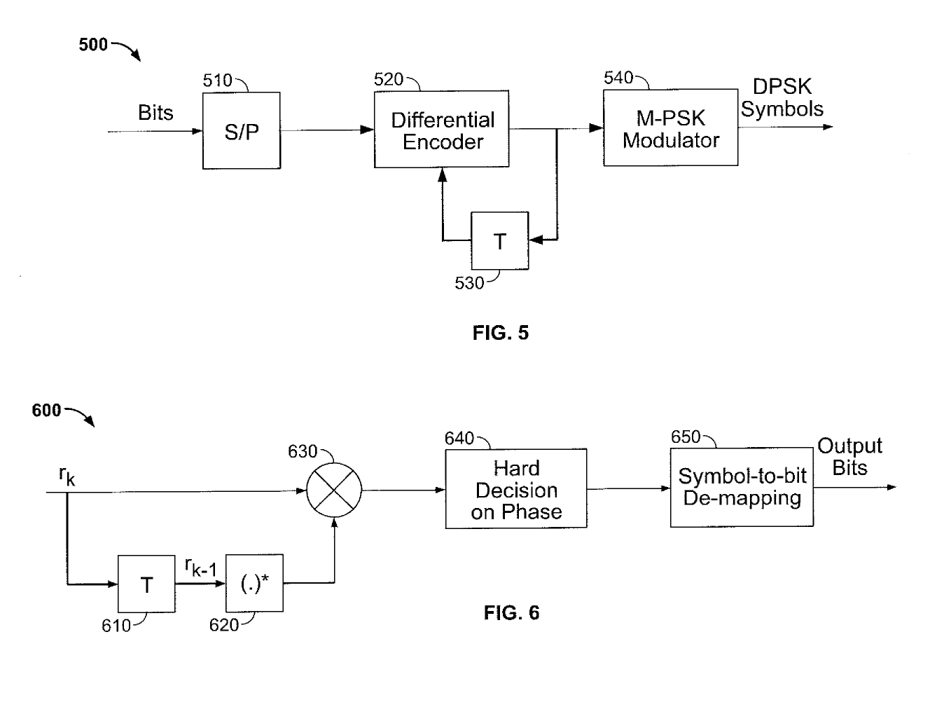

FIG. 5 is a module 500 for generating M-ary DPSK (M-DPSK) signals. The module 500, as illustrated, includes a serial-to-parallel (SIP) converter 510, a differential encoder 520, a delay 530, and an M-PSK modulator 540. In some implementations, the S/P converter 510 receives a sequence of channel-coded bits and divides the sequence into multiple groups, where each group may include m=log₂M channel-coded bits. Without loss of generality, in this disclosure, each bit may take a value of 1 or −1 with an equal probability. In cases where each bit takes a value of 1 or 0, or any other binary values, they may always be simply converted to 1 or −1. The baseband M-DPSK signal for the k-th symbol may be expressed as

xₖ=\sqrt{Pₛ}e^{jφk}, for k=0,1,2, . . . (1)

where j=\sqrt{−1}, Pₛ is the transmitted signal power and φₖ is the phase of the k-th symbol. While in PSK, the information of the bits is carried over directly by φₖ; in DPSK it is carried over by the difference between φₖ and φₖ₋₁, i.e., by δₖ=φₖ−φₖ₋₁. Thus,

φₖ=φₖ₋₁+δₖ, for k=1,2, . . . (2)

where φ₀ may be predetermined. For example, φ₀ may be equal to zero for the binary case and zero, π/M, or another value for M>2. In Equation (2), δₖ may take a value from an M-ary set [symbol] , for instance,

δₖε [symbol] ≡{2lπ/M:l=0,1, . . . ,M−1}. (3)

δₖ may represent the k-th group of m channel-coded bits, b_{k,i}ξ{−1,1}, i=1, 2, . . . , m, according to a predetermined mapping rule. Tables 1-3 show examples of the mapping rules for M=2, 4 and 8 respectively. From Equations (1) and (2), the k-th symbol may be expressed as

xₖ=xₖ₋₁e^{jδ}^{ₖ}, for k=1,2, . . . (4)

Equation (4) indicates that the symbol transmitted in the k-th interval is determined by the output of the differential encoder 520 based on both the k-th group of the channel-coded bits (output form the S/P converter 510) and the previous symbol xₖ₋₁ (output from the delay 530), as illustrated by FIG. 5. It may be seen that in Equation (1), the phase of each symbol, φₖ, belongs to an M-ary set [symbol] , for example,

φₖε [symbol] ≡{2lπ/M+φ₀:l=0,1, . . . ,M−1}. (5)

TABLE 1
Example Mapping Rule for M = 2

| bₖ | δₖ | n |
|---|---|---|
| 1 | 0 | 0 |
| −1 | π | 1 |

TABLE 2
Example Mapping Rule for M = 4

| b_{k, 2} | b_{k, 1} | δₖ | n |
|---|---|---|---|
| 1 | 1 | 0 | 0 |
| 1 | −1 | π/2 | 1 |
| −1 | −1 | π | 2 |
| −1 | 1 | 3π/2 | 3 (or −1) |

TABLE 3
Example Mapping Rule for M = 8

| b_{k, 3} | b_{k, 2} | b_{k, 1} | δₖ | n |
|---|---|---|---|---|
| 1 | 1 | 1 | 0 | 0 |
| −1 | 1 | 1 | π/4 | 1 |
| −1 | 1 | −1 | π/2 | 2 |
| −1 | −1 | −1 | 3π/4 | 3 |
| −1 | −1 | 1 | π | 4 |
| 1 | −1 | 1 | 5π/4 | 5 (or −3) |
| 1 | −1 | −1 | 3π/2 | 6 (or −2) |
| 1 | 1 | −1 | 7π/4 | 7 (or −1) |

In Tables 1-3, the minimum absolute value (MAV) of δₖ, denoted by φ≡min |δₖ|, is zero. The MAV of δₖ may be another non-zero value. For example, the quatemary DPSK (QDPSK) with φ=π/4 may be referred to as π/4-QDPSK. Table 4 lists an example mapping rule for π/4-QDPSK. Equivalently, π/4-QDPSK may be viewed as a regular QDPSK (with φ=0) plus a continuing phase rotation of π/4 from each symbol to the next symbol.

TABLE 4
Example Mapping Rule for π/4-QDPSK

| b_{k, 2} | b_{k, 1} | δₖ | n |
|---|---|---|---|
| 1 | 1 | π/4 | 0 |
| 1 | −1 | 3π/4 | 1 |
| −1 | −1 | 5π/4 | 2 |
| −1 | 1 | 7π/4 | 3 (or −1) |

After the modulated QDPSK signal propagates through an additive white Gaussian noise (AWGN) channel or a flat fading channel, the received k-th symbol at a receiver may be expressed as

\check{r}ₖ=αe^{jθ}xₖ+\check{n}ₖ=α\sqrt{Pₛ}e^{j(φ}^{ₖ}^{+θ)}+\check{n}ₖ, (6)

where α>0 stands for the magnitude propagation coefficient and θ represents an unknown phase offset embedded in the received signal. For the AWGN channel, both α and θ may be constant. For a block fading channel (also called quasi-static fading channel), both α and θ are random variables (RV's) varying independently from one block of N symbols to another block, but may be assumed to be invariant in each block of N symbols. In Equation (6), \check{n}ₖ represents the noise. In general, \check{n}ₖ may be a complex AWGN noise, of which the real and imaginary components are independent zero-mean Gaussian random variables, each with a variance of \check{σ}². \check{n}ₖ is assumed to be independent of \check{n}ₖ, for k≠k′. In some implementations, the received signal is normalized. The received signal after normalization may be expressed as

$$\begin{matrix}{r}_{k} = \frac{{\breve{r}}_{k}}{α \sqrt{{P}_{s}}} = {e}^{j ( {φ}_{k} + θ )} + {n}_{k} , \\ where & ( 7 ) \\ {n}_{k} = \frac{{\breve{n}}_{k}}{α \sqrt{{P}_{s}}} & ( 8 )\end{matrix}$$

is a scaled version of \check{n}ₖ. The variance of each of the real and the imaginary components of nₖ may be given by

σ²=\check{σ}²/α²Pₛ=1/2ρ, (9)

where ρ=α²Pₛ/\check{σ}²=1/2σ² is the signal-to-noise ratio (SNR) of the received signal.

FIG. 6 is a schematic 600 illustrating an example of hard detection (HD) of M-ary DPSK signal. In some implementations, at the receiver, hard detection may be performed on a symbol-by-symbol basis to recover the channel-coded bits. As illustrated in FIG. 6, the k-th received symbol rₖ is multiplied, at 630, with the complex conjugate (at 620) of the previous received signal rₖ₋₁ (output from the delay 610). The receiver may compute the angle

\tilde{δ}ₖ=∠(rₖrₖ₋₁*), (10)

where * represents the complex conjugate, and ∠(.) represents the angle of the argument. The angle \tilde{δ}ₖ represents the phase difference between two consecutively received symbols. Based on \tilde{δ}ₖ, a hard decision may be made at 640 such that, for example,

\hat{δ}ₖ=arg min_{δε} [symbol] |\tilde{δ}ₖ−δ|, (11)

where δ belongs to the set [symbol] of δₖ as listed in the same mapping table used by the transmitter (e.g., Tables 1-4). The information bits are recovered at 650 by de-mapping \hat{δ}ₖ to the output bits \hat{b}_{k,i}, i=1, 2, . . . , m. For the binary case, the HD process may be simplified to

$$\begin{matrix}{\hat{b}}_{k} = \{ \begin{matrix}1 & if {z}_{k} \geq 0 \\ - 1 & if {z}_{k} < 0\end{matrix} , \\ where & ( 12 ) \\ {z}_{k} = {R}_{eal} \{ {r}_{k} {r}_{k - 1}^{*} \} & ( 13 )\end{matrix}$$

with Rₑₐₗ{.} standing for the real component of the argument. In other words, if the conjugate product of two consecutively received symbols has a non-negative real component, it is determined that a bit 1 is transmitted; otherwise, a bit −1 is transmitted.

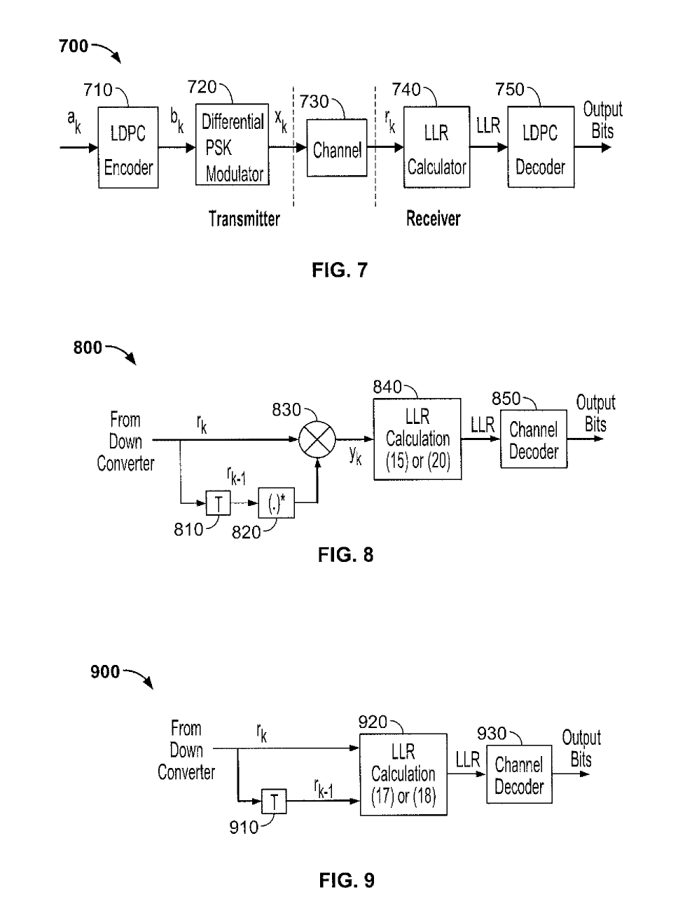

FIG. 7 is a schematic 700 illustrating an example baseband model of a communication system using DPSK modulation with low-density parity check (LDPC) coding. In modern communications systems, modulation techniques are usually used in combination with error-correcting channel coding techniques, such as those based on the turbo code or the low-density parity check (LDPC) code. For instance, in the IEEE 802.1 lad standard, binary DPSK is adopted for the control channel accompanied by a half-rate (672, 336)-LDPC. In such applications, a soft-detection (SD) technique is used exclusively. For example, the DPSK demodulator needs to supply the channel decoder with a soft-detection output for every bit. The SD output may include, for example, likelihood ratio (LR), log-likelihood ratio (LLR), or any other appropriate metric. As illustrated in FIG. 7, the example baseband model includes an LDPC encoder 710, a differential PSK modulator 720, a channel 730, an LLR calculator 740, and an LDPC decoder 750. As an example process, on the transmitter side, information bits {aₖ} may first be channel coded, for example, by the LDPC encoder 710 into coded bits {bₖ}. The coded bits {bₖ} may then be converted into modulated symbols {xₖ} (e.g., DPSK modulated symbols) via the DPSK modulator 720. The modulated symbols {xₖ} may go through a channel 730 and arrive at the receiver. On the receiver side, received symbols {rₖ} may be input into, for example, an LLR calculator 740 for soft detection. Based on the calculated soft metrics (e.g., LLR), the LDPC decoder 750 may determine and produce output bits {\hat{b}ₖ}.

A. Binary Case

In some implementations, an example method to calculate the LLR for Binary DPSK (BDPSK) may be based on zₖ of Equation (13). Following the maximum a posteriori (MAP) principle, the LLR of the k-th bit bₖ may be calculated as

$${LLR}_{k} = ln \frac{p ( {z}_{k} \vert {b}_{k} = 1 )}{p ( {z}_{k} \vert {b}_{k} = - 1 )} + ln \frac{{P}_{r} ( {b}_{k} = 1 )}{{P}_{r} ( {b}_{k} = - 1 )} , \qquad ( 14 )$$

where p(zₖ|bₖ=1) is the probability density function (pdf) of zₖ under the condition of bₖ=1, and Pᵣ(bₖ=1) is the probability for bₖ=1. In the case that bₖ takes 1 or −1 with an equal probability, as assumed in analyses below, the second term on the right-hand side (RHS) of (14) becomes zero and is dropped off. In other cases, when bₖ takes 1 or −1 with an unequal probability, the second term on the RHS of (14) is non-zero and should be included. In (14), the expression for the accurate pdf of zₖ is quite complicated, and an accurate expression is rarely used for LLR calculation. In reality, zₖ may be approximated by a Gaussian random variable, for example, when the SNR is sufficiently high. Substituting the pdf expression of the approximate Gaussian distribution for zₖ into Equation (14) may yield

LLRₖ≈2ρzₖ, (15)

where ρ is the signal-to-noise ratio. In some instances, the above obtained LLR based on Gaussian approximation (GA) of zₖ may not be optimal, in a sense that the resultant bit error (BER) is not the minimum.

In some other implementations, LLR, may be calculated based on the joint pdf of rₖ and rₖ₋₁, rather than on the pdf of zₖ. For example, the LLR of the k-th bit bₖ may be calculated as

$${LLR}_{k} = ln \frac{p ( {r}_{k} , {r}_{k - 1} \vert {b}_{k} = 1 )}{p ( {r}_{k} , {r}_{k - 1} \vert {b}_{k} = - 1 )} . \qquad ( 16 )$$

Alternatively or differently, two other expressions for LLR calculation may be used, for example,

$$\begin{matrix}{LLR}_{k} = ln \frac{{l}_{0} ( 2 ρ \vert {r}_{k} + {r}_{k - 1} \vert )}{{l}_{0} ( 2 ρ \vert {r}_{k} - {r}_{k - 1} \vert )} , \\ and & ( 17 ) \\ {LLR}_{k} = ln \frac{cosh ( 2 ρ \vert {r}_{k} + {r}_{k - 1} \vert )}{cosh ( 2 ρ \vert {r}_{k} - {r}_{k - 1} \vert )} , & ( 18 )\end{matrix}$$

where cos h(x)≡(e^{x}+e^{-x})/2 and I₀(.) is the zero-order modified Bessel function of the first kind. In some instances, soft detection based on Equations (15), (17) and (18) may not differ much in their error rate performances. In some implementations, iterative approaches for LLR calculation may be used and such iterative approaches may involve extra complexity and time delay.

B. M-ary Case

For the more general cases of M-ary DPSK with M>2, the calculation of LLR may be more complicated. As an example, Equation (14) may be applied to the M-ary cases with zₖ replaced by yₖ, where

yₖ=rₖrₖ₋₁*. (19)

yₖ is the conjugate product of two consecutively received symbols rₖ and rₖ₋₁. In some instances, when SNR is sufficiently high, yₖ may be well approximated by a complex Gaussian RV with a mean value equal to e^{jδ}^{ₖ}, where δₖ may have a predetermined mapping relationship (e.g., as in Tables 1-4) with the bits b_{k,i}, i=1˜m. As a result, for the bit b_{k,i}, an approximate LLR expression based on GA may be derived as

LLR_{k,i}≈ρ[max_{nεb}^{^{k,i}}₌₁Rₑₐₗ(yₖe^{-j2nπ/M})−max_{nεb}_{_{k,i}}₌₋₁Rₑₐₗ(yₖe^{-j2nπ/M})], (20)

where n in each term inside the square brackets may be determined by the mapping rule between δₖ and b_{k,i} where b_{k,i} equals to 1 or −1. As an instance, according to the mapping rule in Table 2, for r=1, the values of n satisfying nεb_{k,1}=1 are 0 and −1 (or 3) while for t=2, the values of n satisfying nεb_{k,2}=1 are 0 and 1. When M=2, Equation (20) reduces to Equation (15) of the binary case.

C. Exemplary Receiver Structures

FIG. 8 is a schematic illustrating an example receiver structure 800 for soft detection of DPSK signals. The example receiver structure 800 may, for example, implement the LLR calculation based on Equation (15) or (20) which may involve conjugate multiplication of two DPSK symbols. As illustrated, a received signal (e.g., a radio frequency signal) may first be down-converted (e.g., by the clown-convertor 424 in FIG. 4B) to a baseband signal, which may be further sampled into a digital signal. The received symbols {rₖ} may go through a conjugate multiplication process (e.g., via a delay 810, a complex conjugate operator 820, and a multiplier unit 830) and obtain the conjugate product yₖ of two consecutively received symbols rₖ and rₖ₋₁. At 840, based on the conjugate product yₖ, LLR may be calculated according to Equation (15) or (20). The channel decoder 850 may decode the information bits based on the calculated LLR values output from the LLR calculator.

FIG. 9 is a schematic illustrating another example receiver structure 900 for soft detection of DPSK signals. The example receiver structure 900 may, for example, implement the soft detection of DPSK signals based on Equation (17) or (18). As illustrated, two consecutively received baseband symbols rₖ and rₖ₋₁ may be directly supplied into an LLR calculator 920 for LLR calculation according to Equation (17) or (18). The output LLR values are used to decode information bits by a channel decoder 930.

The example methods described above with respect to Equations (15)-(18) for soft detection of DPSK signals do not exploit the phase offset (PO) embedded in the received signal. As a result, their resulting bit-error rate may be far from the minimum. In some implementations, the PO of the received DPSK signal may be identified and exploited for soft detection of DPSK signals. For example, the receiver may estimate the PO of the received signal and use the estimated PO in LLR calculation. The bit error performance may be improved by exploiting the PO in soft detection of DPSK signals.

### IV. Exemplary Method

In some implementations, the PO may be estimated, for example, based on the received DPSK signal according to maximum likelihood (ML) principle. For example, denote \hat{θ} as an estimate of the unknown PO of the received signal. \hat{θ} may be derived from an approximate maximum-likelihood estimation (MLE) as,

$$\hat{θ} = \frac{1}{M} atan \frac{{I}_{mag} ( {Σ}_{k = 1}^{N} {r}_{k}^{M} )}{{R}_{eal} ( {Σ}_{k = 1}^{N} {r}_{k}^{M} )} + 2 λπ \text{/} M , \qquad ( 21 )$$

where a tan stands for arctangent function, I_{mag}(.) stands for the imaginary component of the argument, and λ may be any integer. As indicated by (21), N received symbols may be used in the MLE, assuming the phase offset is invariant during the period of these N symbols. The LLR may be calculated, for example, using the following expression,

$$\begin{matrix}{LLR}_{k} = ln \frac{{Σ}_{n ∈ {b}_{k , i} = 1} {Σ}_{l = 0}^{M \text{/} 2 - 1} cosh ( 2 ρ {R}_{eal} [ ( {r}_{k - 1} + {r}_{k} {e}^{- j \frac{2 n π}{M}} ) {e}^{- j ( \frac{2 l π}{M} + \hat{θ} )} ] )}{{Σ}_{n ∈ {b}_{k , i} = - 1} {Σ}_{l = 0}^{M \text{/} 2 - 1} cosh ( 2 ρ {R}_{eal} [ ( {r}_{k - 1} + {r}_{k} {e}^{- j \frac{2 n π}{M}} ) {e}^{- j ( \frac{2 l π}{M} + \hat{θ} )} ] )} & ( 22 a ) \\ = ln \frac{{Σ}_{n ∈ {b}_{k , i} = 1} {Σ}_{l = 0}^{M \text{/} 2 - 1} cosh ( 2 ρ {R}_{eal} [ ( {\hat{r}}_{k - 1} + {\hat{r}}_{k} {e}^{- j \frac{2 n π}{M}} ) {e}^{- j \frac{2 l π}{M}} ] )}{{Σ}_{n ∈ {b}_{k , i} = - 1} {Σ}_{l = 0}^{M \text{/} 2 - 1} cosh ( 2 ρ {R}_{eal} [ ( {\hat{r}}_{k - 1} + {\hat{r}}_{k} {e}^{- j \frac{2 n π}{M}} ) {e}^{- j \frac{2 l π}{M}} ] )} , for i = 1 , 2 , … , m , \\ where & ( 22 b ) \\ {\tilde{r}}_{k} ≡ {r}_{k} {e}^{- j \hat{θ}} . & ( 23 )\end{matrix}$$

\tilde{r}ₖ may be considered as a phase-compensated version of the received rₖ, with a phase de-rotation based on the estimated PO \hat{θ}. In some other implementations, the PO may be estimated or otherwise identified based on another technique.

Note that the MLE of θ obtained from (21) has a phase ambiguity of 2λπ/M radians, λ being any integer. However, the effect of introducing a change of 2λπ/M in \hat{θ} is equivalent to a change of the second summation sign in the numerator as well as the denominator of (22a) from Σₗ₌₀^{M/2-1} to Σ_{l=λ}^{M/2-1+λ}, which does not change the final LLR value. Therefore, any phase ambiguity of \hat{θ} equal to 2λπ/M radians does not affect the calculation of LLR.

In some instances, when the SNR is high, (22b) may be well approximated by

$${LLR}_{k , i} \approx 2 ρ {max}_{l = 0 \text{:} ( M \text{/} 2 - 1 ) \\ n ∈ {b}_{k , i} = 1} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert - 2 ρ {max}_{l = 0 \text{:} ( M \text{/} 2 - 1 ) \\ n ∈ {b}_{k , i} = - 1} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert . \qquad ( 24 )$$

Equation (24) helps simplify the calculation by avoiding evaluation of the hyperbolic function and the logarithm function, as well as the division.

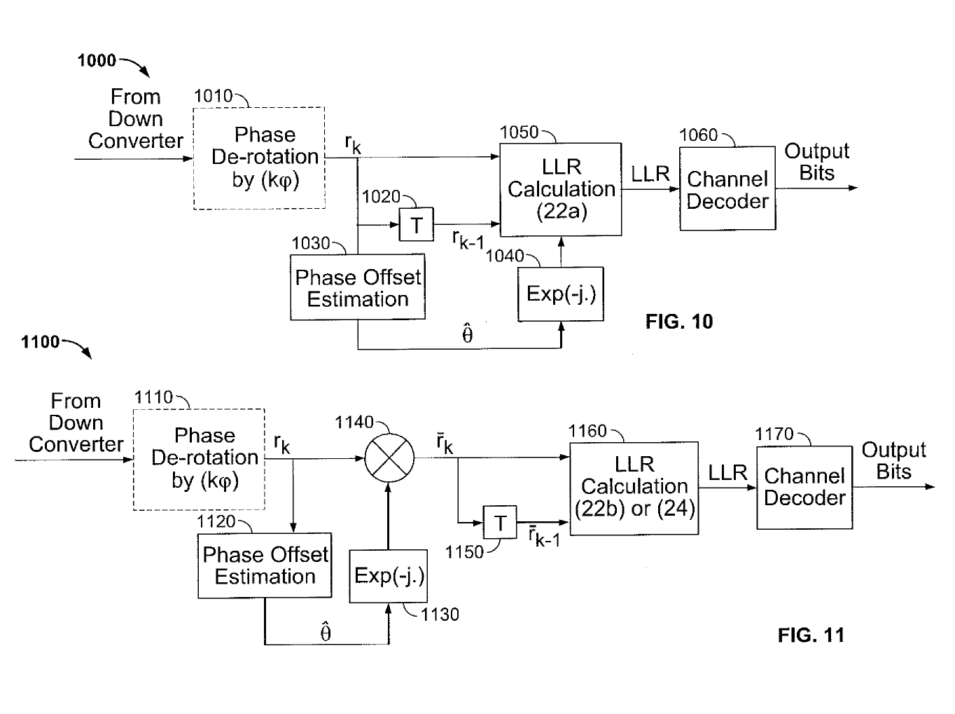

FIG. 10 is a schematic illustrating an example receiver structure 1000 for soft detection of DPSK signals. The example receiver structure 1000 may, for example, implement the soft detection of DPSK signals based on Equations (21)-(23). As illustrated, phase offset estimation may be performed based on the received baseband symbols {rₖ} at 1030. The phase offset may be estimated, for example, according to the example MLE described with respect to Equation (21), or the phase offset may be estimated in another manner, Based on the estimated PO \hat{θ}, a phase de-rotation factor e^{-j\hat{θ}} may be calculated at 1040. The phase de-rotation factor e^{-j\hat{θ}}, together with received symbols rₖ and rₖ₋₁, may be used for LLR calculation according to Equation (22a) at 1050. The channel decoder 1060 may take the calculated LLR and determine output bits.

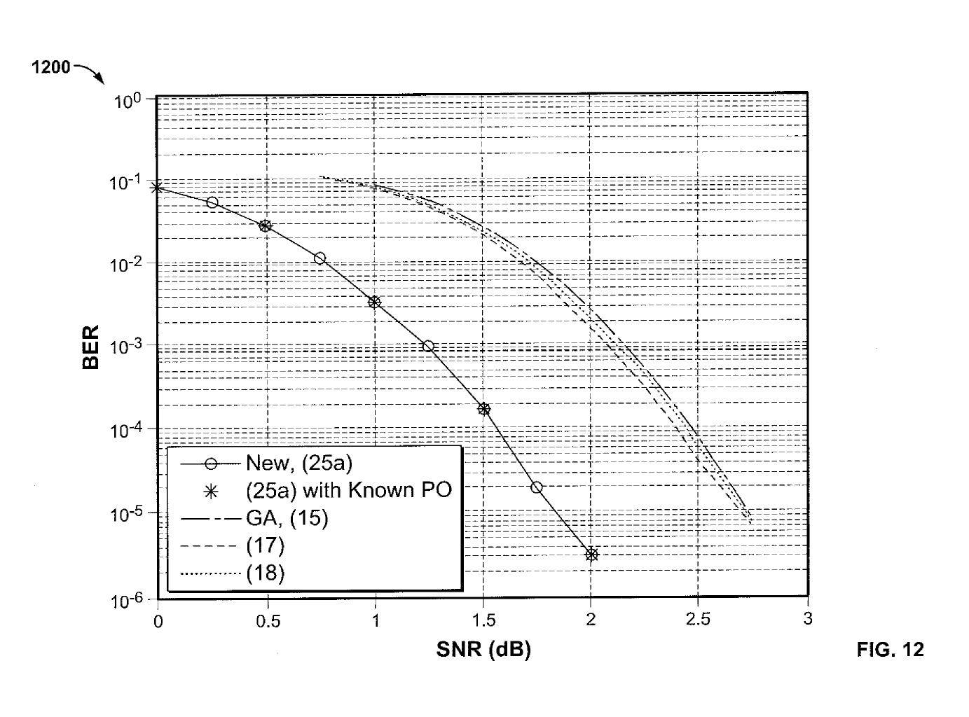

FIG. 11 is a schematic illustrating another example receiver structure 1100 for soft detection of DPSK signals. The example receiver structure 1100 may, for example, implement the soft detection of DPSK signals based on Equations (21)-(24). Similar to the example receiver structure 1000, a phase offset estimate \hat{θ} may be determined based on the received symbols {rₖ} at 1120. Each received symbol rₖ may be phase-compensated based on the phase offset estimate \hat{θ} at 1140 (e.g., by multiplying the de-rotation factor e^{-j\hat{θ}}, or subtracting the phase of rₖ by \hat{θ} radians) and obtain the phase-compensated \tilde{r}ₖ as given in Equation (23). The phase-compensated received symbols, \tilde{r}ₖ and \tilde{r}ₖ₋₁ may be supplied into the LLR calculation at 1160, for example, based on Equation (22b) or (24). Similarly, based on the calculated LLR, a channel decoder 1170 may determine output bits.

The receiver may include additional or different components or may be configured in another manner to perform LLR calculation (e.g., based on Equations (21)-(24)). Note that in FIG. 10 and FIG. 11, the dashed-line box 1010 and 1110 may be used in the case that the minimum absolute value (MAV) of δₖ, denoted by φ, is not zero, (e.g., for the π/4-QDPSK) while being bypassed when φ=0. Specifically, when φ≠0, the k-th received symbol may be de-rotated by kφ radians (i.e., rotated by −kφ radians). Then the symbols after de-rotation may be treated as φ=0.

A. Binary DPSK

In the case of Binary DPSK (BDPSK, M=2), when the example mapping rule of Table 1 is used, Equation (22) may be simplified to

$${LLR}_{k} = ln \frac{cosh [ 2 ρ {R}_{eal} ( {\tilde{r}}_{k} + {\tilde{r}}_{k - 1} ) ]}{cosh [ 2 ρ {R}_{eal} ( {\tilde{r}}_{k} - {\tilde{r}}_{k - 1} ) ]} \qquad ( 25 a )$$

for bₖ.

Alternatively or additionally, the high SNR approximation based on Equation (24) may be applied and the LLR in (25a) may be approximated by

LLRₖ≈2ρ[|Rₑₐₗ(\tilde{r}ₖ+\tilde{r}ₖ₋₁)|−|Rₑₐₗ(\tilde{r}ₖ−\tilde{r}ₖ₋₁)|]. (25b)

In this case, the LLR for each bit depends on the difference between the absolute value of the real part of the sum of two consecutively received symbols with phase compensation, and the absolute value of the real part of the difference of two consecutively received symbols with phase compensation.

B. Quaternary DPSK

In the case of Quaternary DPSK (QDPSK, M=4), when the example mapping rule of Table 2 is used, Equations (22a) and (22b) (collectively, Equation (22)) may be simplified as

$$\begin{matrix}{LLR}_{k , 2} = ln \frac{{Σ}_{n = 0}^{1} {Σ}_{l = 0}^{1} cosh ( 2 ρ {R}_{eal} [ ( {\tilde{r}}_{k - 1} + {\tilde{r}}_{k} {e}^{- j \frac{n π}{2}} ) {e}^{- j \frac{l π}{2}} ] )}{{Σ}_{n = 2}^{3} {Σ}_{l = 0}^{1} cosh ( 2 ρ {R}_{eal} [ ( {\tilde{r}}_{k - 1} + {\tilde{r}}_{k} {e}^{- j \frac{n π}{2}} ) {e}^{- j \frac{l π}{2}} ] )} \\ and & ( 26 a ) \\ {LLR}_{k , 1} = ln \frac{{Σ}_{n = - 1}^{0} {Σ}_{l = 0}^{1} cosh ( 2 ρ {R}_{eal} [ ( {\tilde{r}}_{k - 1} + {\tilde{r}}_{k} {e}^{- j \frac{n π}{2}} ) {e}^{- j \frac{l π}{2}} ] )}{{Σ}_{n = 1}^{2} {Σ}_{l = 0}^{1} cosh ( 2 ρ {R}_{eal} [ ( {\tilde{r}}_{k - 1} + {\tilde{r}}_{k} {e}^{- j \frac{n π}{2}} ) {e}^{- j \frac{l π}{2}} ] )} & ( 26 b )\end{matrix}$$

for b_{k,2} and b_{k,1}, the second and first bit of the k-th DPSK symbol, respectively.

Alternatively or additionally, the high SNR approximation based on Equation (24) may be applied and the LLR in (26a) and (26b) may be respectively approximated by

$$\begin{matrix}{LLR}_{k , 2} \approx 2 ρ {max}_{l = 0 , 1 \\ n = 0 , 1} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert - 2 ρ {max}_{l = 0 , 1 \\ n = 2 , 3} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert & ( 27 a ) \\ {LLR}_{k , 1} \approx 2 ρ {max}_{l = 0 , 1 \\ n = - 1 , 0} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert - 2 ρ {max}_{l = 0 , 1 \\ n = 1 , 2} \vert {R}_{eal} [ ( {\tilde{r}}_{k - 1} + {\tilde{r}}_{k} {e}^{- j \frac{2 n π}{M}} ) {e}^{- j \frac{2 l π}{M}} ] \vert . & ( 27 b )\end{matrix}$$

C. Octal DPSK

In the case of Octal DPSK (ODPSK, M=8), when the example mapping rule of Table 3 is used, Equation (22) may be simplified as

$$\begin{matrix}{LLR}_{k , 3} = ln \frac{{Σ}_{n = - 3}^{0} {Σ}_{l = 0}^{3} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )}{{Σ}_{n = 1}^{4} {Σ}_{l = 0}^{4} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )} , & ( 28 a ) \\ {LLR}_{k , 2} = ln \frac{{Σ}_{n = - 1}^{2} {Σ}_{l = 0}^{3} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )}{{Σ}_{n = 3}^{6} {Σ}_{l = 0}^{3} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )} \\ and & ( 28 b ) \\ {LLR}_{k , 1} = ln \frac{{Σ}_{n = \{ 0 , 1 , 4 , 5 \}} {Σ}_{l = 0}^{3} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )}{{Σ}_{n = \{ 2 , 3 , 6 , 7 \}} {Σ}_{l = 0}^{3} cosh ( 2 ρ {R}_{eal} [ ( {\tilde{r}}_{k - 1} + {\tilde{r}}_{k} {e}^{- j \frac{n π}{4}} ) {e}^{- j \frac{l π}{4}} ] )} & ( 28 c )\end{matrix}$$

for b_{k,3}, b_{k,2} and b_{k,1}, respectively. The application of (24) to ODPSK for high SNR approximation may be straightforward.

In the case of M-DPSK, M>8, LLR calculation may be straightforwardly derived based on the principles of Equations (22) and (24). Note that the techniques described in this disclosure may be applied to any M-DPSK mapping rules including those different than the example ones in Tables 1-4. The LLR calculation may be modified accordingly based on the mapping rules.

### V. Simulation Results

FIG. 12 a plot 1200 illustrating example bit error rate (BER) performances of Binary-DPSK with (672,336)-LDPC under AWGN Channel. In performing the simulation, the used LDPC is specified by the IEEE 802.11 ad standard document. The plot 1200 includes the bit-error rates obtained via computer simulation using various LLR calculation techniques. As indicated, for a given SNR value, using Gaussian approximation (GA) according to Equation (15) for soft detection of BDPSK signal yields the highest BER compared to the other four illustrated techniques, although using Equation (17) or (18) shows negligible performance improvement over the case using GA in Equation (15). On the other hand, exploiting phase offset for soft detection of BDPSK signal (e.g., by estimating the phase offset θ and using Equation (25a) for LLR calculation based on the estimated phase offset \hat{θ}) demonstrate significant performance improvement (for example, about 0.9 dB SNR improvement at BER=10⁻⁵) over the above three schemes. In the illustrated example, N=672 bits are used in the MLE for the phase offset estimation in simulation. Furthermore, FIG. 12 shows that when Equation (25a) is used for LLR calculation, using the phase offset estimate (e.g., as obtained according to Equation (21)) yields the same (or substantially the same) error performance as that may be obtained by using the actual phase offset assuming the receiver knows the exact phase offset.

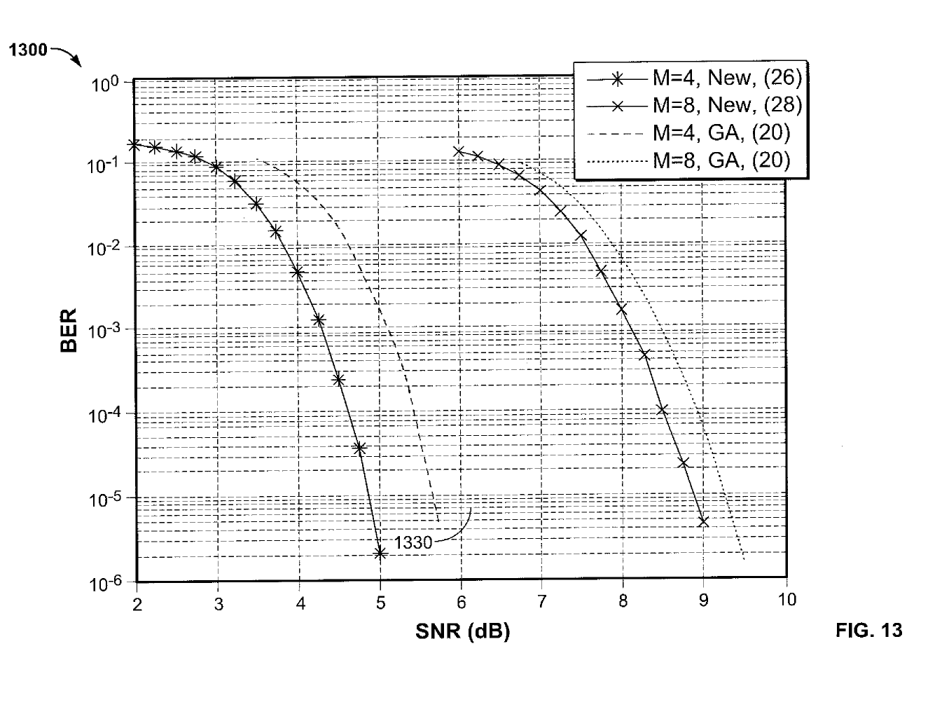

FIG. 13 is a plot 1300 illustrating example BER performances of Quaternary-DPSK and 8-DPSK with the same (672,336)-LDPC under AWGN Channel. In the illustrated example, N=336 symbols and N=896 symbols are used for phase offset estimation for QDPSK and 8-DPSK, respectively. As indicated, using the Equation (26) for soft detection of QDPSK signals provides an improvement of around 0.9 dB, while using Equation (28) for soft detection of 8-DPSK provides an improvement of about 0.5 dB over the GA approach based on Equation (15), respectively.

As demonstrated by computer simulation above, exploiting phase offset in soft detection of DPSK signal, for example, by estimating the phase offset and using the estimated phase offset in soft detection output (e.g., LLR) calculation may improve the error rate performance. In some instances, these techniques may help reduce the transmitter power without sacrificing the data rate and/or help increase data throughput (e.g., by increasing the order of modulation).

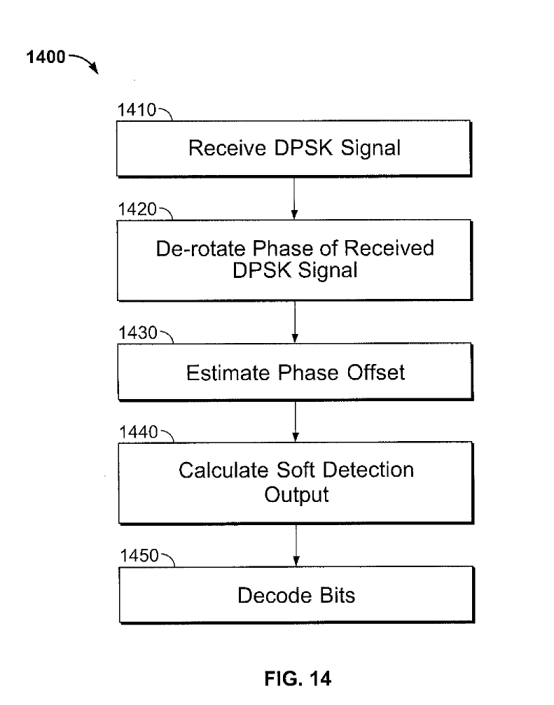

FIG. 14 is a flowchart illustrating an example method 1400 for soft-detection of M-ary DPSK signal. The receiver may be a receiver in a wireless or wireline communication system, or may be another appropriate device. The receiver may be, for example, the example receiver 104 in FIG. 1. In some instances, the receiver may be included in a network node (e.g., the example network node 200 described with respect to FIG. 2) or a UE (e.g., the example UE 300 described with respect to FIG. 3). In some implementations, the receiver may include identical or similar components to the example receiver 420 in FIG. 4B or have an identical or similar structure to one or more of the example receiver structure in FIGS. 8-11. In some implementations, the receiver may be configured in another manner.

At step 1410, a DPSK signal is received at the receiver. The DPSK signal, for example, may include a sequence of DPSK modulated symbols. In some instances, the DPSK may be used in combination with a channel code (e.g., convolution code, turbo code, LDPC code, etc.). In some instances, the received M-ary DPSK signal may suffer from an unknown phase offset θ. The phase offset θ may be a random variable and be introduced, for example, by a channel that the M-ary DPSK signal passes through, by a phase drifting due to imperfect frequency synchronization, or any other possible factor. The phase offset θ may be constant for all received M-ary DPSK symbols (e.g., under an AWGN or flat fading channel), or invariant over a number of M-ary DPSK symbols (e.g., under a block-fading channel).

In some implementations, the DPSK may be M-ary DPSK, where M may be, for example, 2, 4, 8, 16, 32, 64, etc. In some implementations, the M-ary DPSK may optionally have a phase rotation φ in each symbol. For example, the φ-MDPSK. As an example, for φ=π/4, M==4, it is a typical π/4-QDPSK.

At step 1420, the phase of the received φ-MDPSK signal is de-rotated. In some implementations, this step may be optional and it may only be performed for the φ-MDPSK signal. Specifically, the phase of the received signal is de-rotated by the same amount of the phase rotation φ introduced on the transmitter side. For example, the k-th received symbol may be de-rotated by kφ radians (i.e., rotated by −kφ radians). The resulting signal may be treated as a regular M-ary DPSK signal with φ=0. The phase of the received signal may be de-rotated prior to estimating the unknown phase offset of the received signal.

At step 1430, the phase offset of the received DPSK signal is estimated or otherwise identified. For instance, the phase offset estimate may be denoted as \hat{θ}. In some implementations, the phase offset θ may be estimated based on the maximum likelihood (ML) principle, or any other appropriate principle. For example, the phase offset θ may be estimated according to the MLE described with respect to Equation (21). The example MLE, although it may produce a phase ambiguity, suffices to provide accurate phase offset estimation for soft detection of the DPSK signal as demonstrated in the simulation result presented in FIG. 12.

In some implementations, the phase offset estimation may be based solely on the received DPSK signal (e.g., according to the MLE in Equation (21)) without requiring dedicated training symbols. Alternatively or additionally, the phase offset θ may be estimated based on preambles, training symbols, or any other type of signal transmitted by the transmitter. As an example, the phase offset θ may be estimated based on preambles that are, for example, received prior to the DPSK signal. In one implementation, the receiver may estimate the phase offset θ based on the preamble and directly apply the estimated phase offset to soft detection of the DPSK signal (e.g., plugging the estimated phase offset into LLR calculation). In another example, the receiver may further perform a fine estimation based on the received DPSK signal and apply the fine-tuned phase offset estimate to calculating the soft detection output. In some implementations, the phase offset of the DPSK signal may be estimated or identified based on a phase offset estimation of another type of signal (e.g., PSK signal, QAM signal, etc.) that is transmitted in connection with the DPSK signal (e.g., within the same packet, sharing an identical or similar channel, etc.). Additional or different techniques may be used to estimate and identify the phase offset of the received DPSK signal.

At step 1440, a soft detection output is calculated. The soft detection output may include a soft detection metric (e.g., log-likelihood ratio (LLR)) for each bit. In some implementations, the LLR of a single bit bₖ may be derived based on the conditional joint probability density function (pdf) of two consecutively received DPSK symbols (e.g., rₖ and rₖ₋₁) conditioned on the value of the bₖ (e.g., bₖ=1 or bₖ=−1). The derivation of the soft detection output may explicitly account for and exploit the phase offset of the received DPSK signal. In some implementations, the receiver may employ the phase offset estimate \hat{θ} obtained at 1430 in LLR calculations. For example, the LLR for each bit of an M-ary DPSK symbol may be calculated according to Equation (22) or Equation (24) (e.g., when SNR is high). More specifically, the LLR for each bit of a BDPSK, QDPSK, and 8-DPSK symbol may be calculated according to Equations (25), (26)-(27), and (28), respectively. LLR for each bit of higher order of Mary QPSK (M>8) and its respective high SNR approximation may be generalized based on the Equations (22) and (24) accordingly. In some implementations, each received M-ary DPSK symbol may be phased compensated based on the phase offset estimate \hat{θ} (for example, by subtracting the phase offset estimate \hat{θ} from the received signal, de-rotating the received signal by \hat{θ} radians, or rotating the received signal by −\hat{θ} radians) prior to calculating the soft detection metrics, for example, as shown in FIG. 11.

At step 1450, the information bits are decoded and output, for example, by a channel decoder. The channel decoder may perform a decoding algorithm matched to the channel coding used by the transmitter. The channel decoder may include, for example, a turbo code decoder, an LDPC decoder, or any other type of decoder. The channel decoder may determine whether an output bit is 1 or −1 (or 0) based on the calculated soft detection output (e.g., the LLR for each bit).

In some instances, the receiver capable to exploit phase offset for soft detection of DPSK signal may be referred to as an advanced DPSK receiver. The advanced DPSK receiver may provide enhanced receiver performance compared to the legacy DPSK receiver that does not exploit phase offset for DPSK signals. In some implementations, in order to take advantage of receiver performance enhancement, the receiver may send a signaling to a transmitter to indicate that the receiver may provide enhanced receiver performance that includes, for example, exploiting the phase offset in soft detection of the DPSK signal. The signaling may be transmitted before, during, or after receiving the DPSK signal. As an example, the signaling may be transmitted prior to the transmitter transmitting DPSK modulated data. Based on such signaling, the transmitter may adjust its transmitting power, modulation order, channel coding scheme, or any other appropriate parameter to improve or optimize the system performance. In some implementations, the signaling may be one-bit control information that indicates whether the receiver is an advanced receiver or not. In some other implementations, the signaling may include more than one bit that may convey additional information that includes, for example, a quantitative performance improvement metric for M-ary DPSK signal, for M=2, 4, 8, 16 . . . .

### VI. Exemplary Embodiments

In one embodiment, a method performed at a receiver of a communication system may be provided. The method may include receiving an Mary differential phase-shift keying (DPSK) signal containing a phase offset and optionally a phase rotation; estimating the phase offset of the received signal; and/or calculating a soft detection metric employing the estimated phase offset to provide enhanced receiver performance. The method may include subtracting the phase offset estimate from the received signal prior to calculating the soft detection metric and/or de-rotating the phase of the received signal by the same amount of the phase rotation prior to estimating the phase offset of the received signal. Estimating the phase offset of the received signal may be based on maximum likelihood principle. The method may include transmitting a signal or signaling, from the receiver to a transmitter, indicating that the receiver is capable of receiver performance enhancement. The soft detection metric may be a log-likelihood ratio (LLR) for soft detection of the received M-ary DPSK signal and the calculation of the LLR may be based upon a conditional joint probability density function of two consecutively received symbols based on equations of (22)-(28) noted above. The method may include additional, fewer, or alternative steps.

In another embodiment, a receiver of a communication network may be provided. The receiver may include one or more processors configured to: receive an M-ary differential phase-shift keying (DPSK) signal containing a phase offset and optionally a phase rotation; estimate the phase offset of the received signal; and/or calculate a soft detection metric employing the estimated phase offset to provide enhanced receiver performance. The one or more processors may further be configured to subtract the phase offset estimate from the received signal prior to calculating the soft detection metric and/or de-rotate the phase of the received signal by the same amount of the phase rotation prior to estimating the phase offset of the received signal. Estimating the phase offset of the received signal may be based on maximum likelihood principle. The one or more processors may further be configured to send a signal or signaling, from the receiver to a transmitter, indicating that the receiver is capable of receiver performance enhancement. The soft detection metric may be log-likelihood ratio (LLR) for soft detection of the received M-ary DPSK signal and the calculation of the LLR may be based on a conditional joint probability density function of two consecutively received symbols based on equations (22)-(28). The receiver may include additional, fewer, or alternate components and functionality.

In another embodiment, a method performed at a receiver of a communication system may be provided. The method may include receiving a signal including a sequence of differential phase-shift keying (DPSK) modulated symbols including an unknown phase offset; estimating the unknown phase offset of the received signal; and/or calculating a likelihood ratio for each bit of the DPSK modulated symbols based upon the estimated phase offset. The method may include subtracting the estimated phase offset from a phase of the received signal prior to calculating the likelihood ratio for each bit of the DPSK modulated symbols. The likelihood ratio may comprise a log-likelihood ratio (LLR) of each bit being 1 or −1. The likelihood ratio may be based on a conditional joint probability density function of two consecutively received symbols. The DPSK may be binary DPSK, quaternary DPSK, octal DPSK, or DPSK of higher orders. The method may further include de-rotating the received signal by a predefined phase prior to estimating the unknown phase offset of the received signal. Estimating the unknown phase offset of the received signal may be based on maximum likelihood principle. The method may include determining bit values for the DPSK modulated symbols using the calculated likelihood ratio for each bit. The method may include additional, fewer, or alternative steps.

In another embodiment, a receiver of a communication network may be provided. The receiver may include (1) means for receiving an M-ary differential phase-shift keying (DPSK) signal containing a phase offset and optionally a phase rotation; (2) means for estimating the phase offset of the received signal; and/or (3) means for calculating a soft detection metric employing the estimated phase offset to provide enhanced receiver performance. The receiver may include means for subtracting the phase offset estimate from the received signal prior to calculating the soft detection metric, and/or means for de-rotating the phase of the received signal by the same amount of the phase rotation prior to estimating the phase offset of the received signal. Estimating the phase offset of the received signal may be based on maximum likelihood principle. The “means for” functionality noted above may be provided by one or more processors and/or computer instructions stored on non-transitory memory. The receiver may include additional, fewer, or alternate components and functionality.

Although several illustrated examples are related to wireless communications, the example techniques described here may be applied to any other type of communications, such as wireline (e.g., cooper wire, fiber optical etc.) communication, satellite communication, etc. In addition, the example technique described in this disclosure may be applied to any other appropriate application that may involve signal modulation and detection (e.g., data storage, data compression, data recovery, etc.).

While several implementations have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

While the above detailed description has shown, described, and pointed out the fundamental novel features of the disclosure as applied to various implementations, it will be understood that various omissions and substitutions and changes in the form and details of the system illustrated may be made by those skilled in the art, without departing from the intent of the disclosure. In addition, the order of method steps are not implied by the order they appear in the claims.

1. A method performed at a receiver of a communication system, the method comprising:
receiving an M-ary differential phase-shift keying (DPSK) signal containing a phase offset and optionally a phase rotation, wherein transmission through a fading channel causes the phase offset in the received signal;
estimating the phase offset of the received signal; and
calculating a soft detection metric employing the estimated phase offset to provide enhanced receiver performance.

2. The method of claim 1, comprising subtracting the phase offset estimate from the received signal prior to calculating the soft detection metric.

3. The method of claim 1, further comprising de-rotating the phase of the received signal by the same amount of the phase rotation prior to estimating the phase offset of the received signal.

4. The method of claim 1, wherein estimating the phase offset of the received signal is based on maximum likelihood principle.

5. The method of claim 1, comprising transmitting a signaling, from the receiver to a transmitter, indicating that the receiver is capable of receiver performance enhancement.

6. The method of claim 1, wherein the soft detection metric is a log-likelihood ratio (LLR) for soft detection of the received M-ary DPSK signal and the calculation of the LLR is based on a conditional joint probability density function of two consecutively received symbols.

7. A receiver of a communication network, comprising:
one or more processors configured to:
receive an M-ary differential phase-shift keying (DPSK) signal containing a phase offset and optionally a phase rotation, wherein transmission through a fading channel causes the phase offset in the received signal;
estimate the phase offset of the received signal; and
calculate a soft detection metric employing the estimated phase offset to provide enhanced receiver performance.

8. The receiver of claim 7, the one or more processors further configured to subtract the phase offset estimate from the received signal prior to calculating the soft detection metric.

9. The receiver of claim 7, the one or more processors further configured to de-rotate the phase of the received signal by the same amount of the phase rotation prior to estimating the phase offset of the received signal.

10. The receiver of claim 7, wherein estimating the phase offset of the received signal is based on maximum likelihood principle.

11. The receiver of claim 7, the one or more processors further configured to send a signaling, from the receiver to a transmitter, indicating that the receiver is capable of receiver performance enhancement.

12. The receiver of claim 7, wherein the soft detection metric is log-likelihood ratio (LLR) for soft detection of the received M-ary DPSK signal and the calculation of the LLR is based a conditional joint probability density function of two consecutively received symbols.

13. A method performed at a receiver of a communication system, the method comprising:
receiving a signal including a sequence of differential phase-shift keying (DPSK) modulated symbols including an unknown phase offset, wherein transmission through a fading channel causes the unknown phase offset in the received signal;
estimating the unknown phase offset of the received signal; and
calculating a likelihood ratio for each bit of the DPSK modulated symbols based upon the estimated phase offset.

14. The method of claim 13, comprising subtracting the estimated phase offset from a phase of the received signal prior to calculating the likelihood ratio for each bit of the DPSK modulated symbols.

15. The method of claim 13, wherein the likelihood ratio comprises a log-likelihood ratio (LLR) of each bit being 1 or −1.

16. The method of claim 13, wherein the likelihood ratio is based on a conditional joint probability density function of two consecutively received symbols.

17. The method of claim 13, wherein the DPSK is binary DPSK, quaternary DPSK, or octal DPSK.

18. The method of claim 13, wherein the DPSK is offset DPSK, the method further comprising de-rotating the received signal by a predefined phase prior to estimating the unknown phase offset of the received signal.

19. The method of claim 13, wherein estimating the unknown phase offset of the received signal is based on maximum likelihood principle.

20. The method of claim 13, further comprising determining bit values for the DPSK modulated symbols using the calculated likelihood ratio for each bit.
